(19) United States
(12) Patent Application Publication
(10) Pub. No.: US 2023/0180890 A1
(43) Pub. Date: Jun. 15, 2023

(54) AIRBAG WITH INTERNAL BEAD LAYER

(71) Applicant: NIKE, Inc., Beaverton, OR (US)

(72) Inventors: Dervin A. James, Hillsboro, OR (US); Ryan R. Larson, Portland, OR (US); Todd A. Waatti, Battle Ground, WA (US)

(73) Assignee: NIKE, Inc., Beaverton, OR (US)

(21) Appl. No.: 18/060,833

(22) Filed: Dec. 1, 2022

Related U.S. Application Data
(60) Provisional application No. 63/285,111, filed on Dec. 2, 2021.

(51) Int. Cl. A43B 13/20; B32B 3/08; B32B 27/08; B32B 37/20; B32B 7/05; B32B 3/30; B32B 38/10; B32B 38/00

(52) U.S. Cl. CPC A43B 13/20; B32B 3/30; B32B 3/085; B32B 7/05; B32B 27/08; B32B 37/203; B32B 38/10; B32B 38/0012; B32B 2250/24; B32B 2255/10; B32B 2255/26; B32B 2272/00; B32B 2307/412; B32B 2307/4026; B32B 2307/7242; B32B 2437/00

(57) ABSTRACT

A bladder for a wearable article, the bladder comprising a first barrier sheet including a first surface and a second surface disposed on an opposite side from the first surface, a second barrier sheet including a third surface and a fourth surface disposed on an opposite side from the third surface and attached to the second surface of the first barrier sheet to define a chamber, and a bead layer disposed on at least one of the second surface or the fourth surface within the chamber.

### CROSS REFERENCE TO RELATED APPLICATION

This non-provisional U.S. Patent Application claims priority under 35 U.S.C. §119(e) to U.S. Provisional Pat. Application Serial No. 63/285,111, filed Dec. 2, 2021, the disclosure of which is hereby incorporated by reference in its entirety.

### FIELD

The present disclosure relates to a system and method for producing bladders with an internal bead layer.

### BACKGROUND

This section provides background information related to the present disclosure and is not necessarily prior art.

Bladders, or airbags, are used in articles of footwear and apparel to provide cushioning and other performance characteristics during use. Such bladders typically include one or more polymeric films forming an outer layer of the bladder and defining an interior chamber that contains a compressible material, such as a fluid, an elastomeric material, and/or a tensile structure. The fluid and/or elastomeric material provide the bladder with the ability to absorb and cushion forces applied thereto while the tensile member helps maintain a desired shape of the bladder in a relaxed state.

In articles of footwear, bladders are traditionally concealed within a sole structure of the article of footwear to provide cushioning and responsiveness to a wearer during use. Such bladders may be contained within a midsole of the article of footwear and, as a result, are hidden from view. Alternatively, a midsole may include one or more openings where the bladder is visible at a sidewall of the sole structure. Such openings may be so large, in fact, that the bladder forms a maj ority of a thickness of the sole structure. In such a configuration, a sidewall of the bladder may extend between and join an upper of the article of footwear and a ground-contacting surface of the article of footwear.

Regardless of the particular structure of the bladder and its relationship to other components of the sole structure, the shape, color, and overall appearance of the bladder are typically designed to complement the surrounding structure of the article of footwear to provide the article of footwear with a desired appearance.

### DRAWINGS

The drawings described herein are for illustrative purposes only of selected configurations and not all possible implementations, and are not intended to limit the scope of the present disclosure.

FIG. 1A is an elevation view of an article of footwear including an example of a bladder in accordance with the principles of the present disclosure;

FIG. 1B is a perspective view of an example of a bladder in accordance with the principles of the present disclosure;

FIG. 2A is an elevation view of an article of footwear including an example of a bladder in accordance with the principles of the present disclosure;

FIG. 2B is a perspective view of an example of a bladder in accordance with the principles of the present disclosure;

FIG. 2C is a perspective view of an example of a bladder in accordance with the principles of the present disclosure;

FIG. 3 is a schematic view of an example of a system for forming bladders in accordance with the principles of the present disclosure;

FIG. 4A is a perspective view of an example extrusion system of the system of FIG. 3;

FIG. 4B is an example of a barrier sheet having a bead layer applied by the extrusion system of FIG. 4A;

FIG. 5A is a schematic view of a vacuum forming press of the system of FIG. 3, where the vacuum forming press is in an open configuration;

FIG. 5B is a schematic view of the vacuum forming press of FIG. 5A, where the vacuum forming press is in a closed configuration;

FIG. 5C is a schematic view of the vacuum forming press of FIG. 5A, where a sealing system of the vacuum forming press is actuated;

FIG. 5D is a schematic view of the vacuum forming press of FIG. 5A, where a vacuum is drawn through vacuum ports of the vacuum forming press;

FIG. 5E is a schematic view of the vacuum forming press of FIG. 5A, where a bladder formed within the vacuum forming press is ejected from the vacuum forming press;

FIG. 6A is a schematic view of a trimmer of the system of FIG. 3, where the trimmer is in an open configuration;

FIG. 6B is a schematic view of the trimmer of FIG. 6A, where the trimmer is in a closed configuration;

FIG. 6C is a schematic view of the trimmer of FIG. 6A, where a trimmed bladder is ejected from the trimmer and separated from barrier sheets; and

FIG. 7 is a schematic perspective view of the trimmer of FIG. 6A, where the barrier sheets are provided to a milling system.

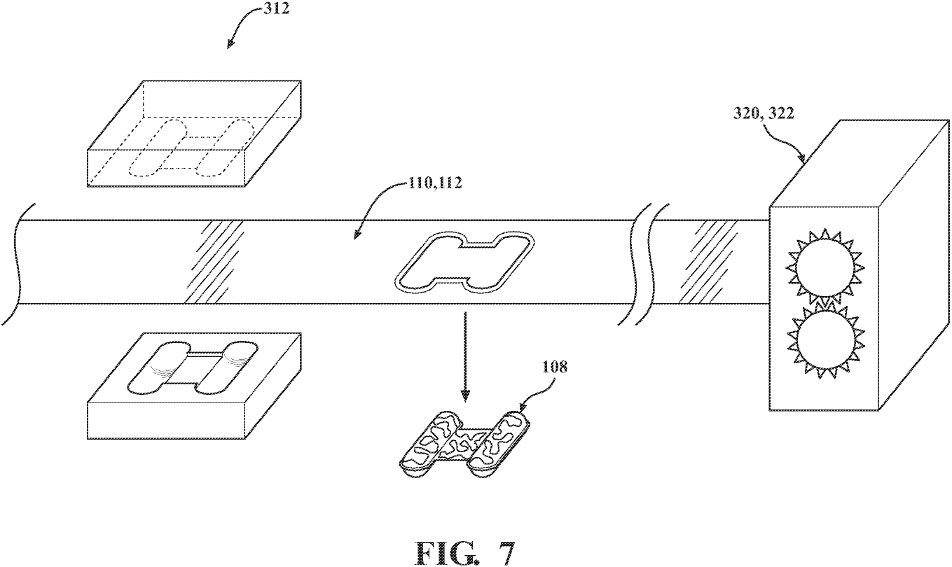

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The details of one or more implementations of the disclosure are set forth in the accompanying drawings and the description below. Other aspects, features, and advantages will be apparent from the description, the drawings, and the claims.

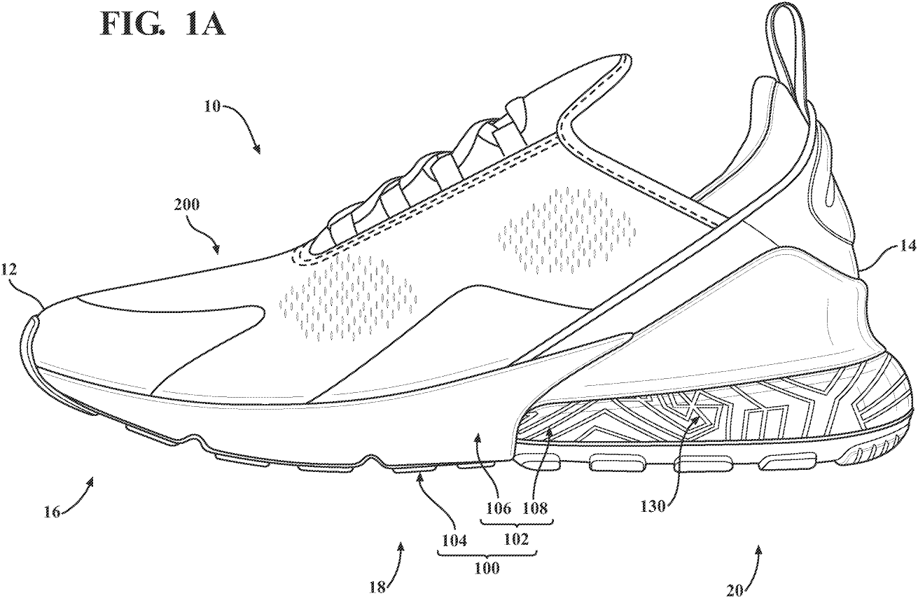

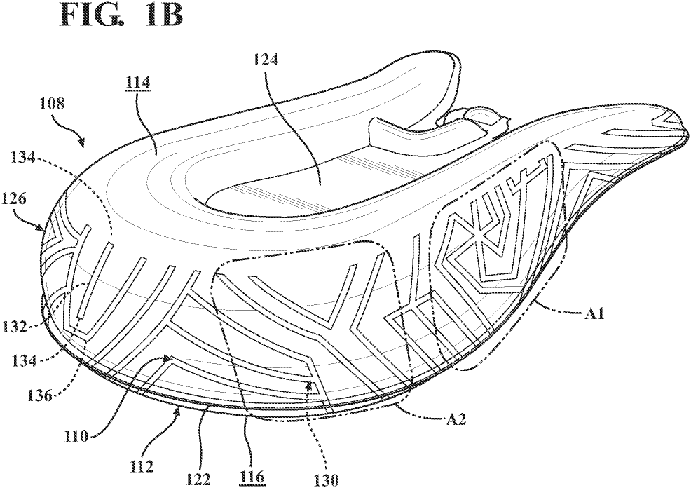

Referring to FIG. 1A, an article of footwear 10 includes a sole structure 100 and an upper 200 attached to the sole structure 100. The footwear 10 may further include an anterior end 12 associated with a forward-most point of the footwear 10, and a posterior end 14 corresponding to a rearward-most point of the footwear 10. The article of footwear 10 may be divided into one or more regions. The regions may include a forefoot region 16, a mid-foot region 18, and a heel region 20. The forefoot region 16 corresponds with phalanges and metatarsal bones of a foot. The mid-foot region 18 may correspond with an arch area of the foot, and the heel region 20 may correspond with rear portions of the foot, including a calcaneus bone.

The sole structure 100 includes a midsole 102 configured to provide cushioning properties and an outsole 104 attached to the midsole 102 to provide a ground-engaging interface of the sole structure 100. As shown, the midsole 102 is constructed as a composite structure including an elastomeric cushioning element 106 in a forefoot region and a bladder 108 disposed in a heel region. Here, the cushioning element 106 defines a first portion of an outer periphery of the sole structure 100 in the forefoot region, while the bladder 108 defines a second portion of the outer periphery of the sole structure 100 in the heel region that is both exposed and visible along the heel region. While FIG. 1A provides one example of a sole structure 100 including a bladder 108 in the heel region, the principles of the present disclosure can be applied to a bladder at any location of a sole structure—exposed or otherwise. Furthermore, the principles of the present disclosure can be applied to any bladder for use in any portion of an article of footwear or apparel.

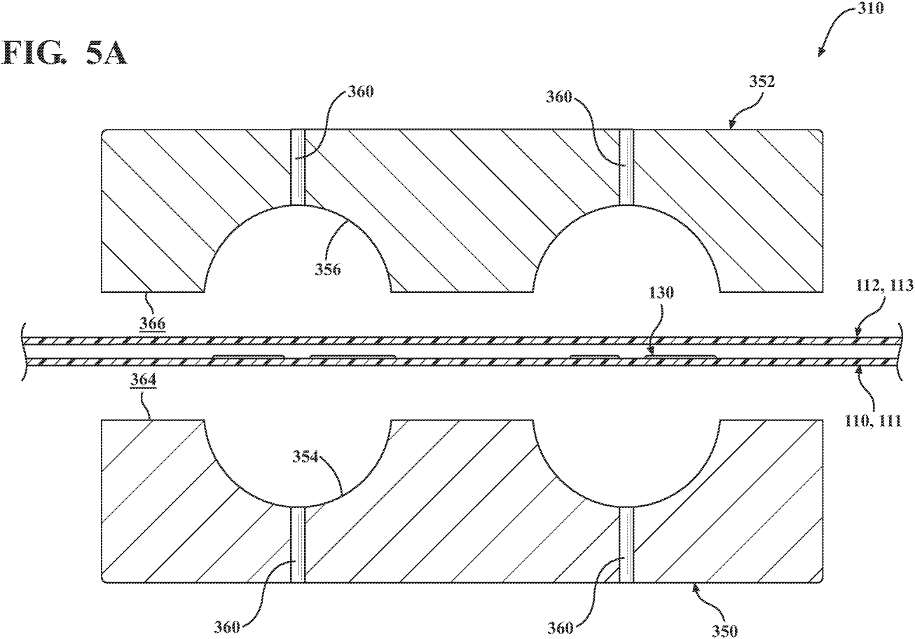

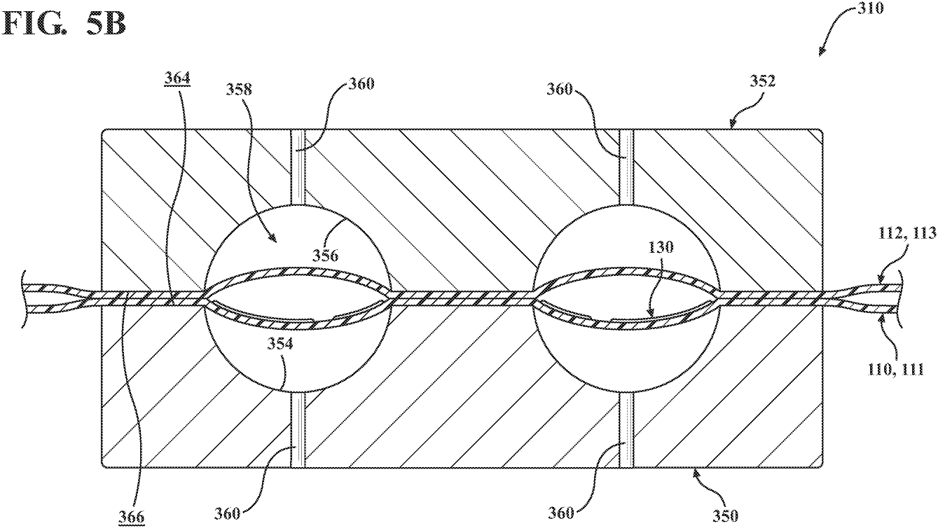

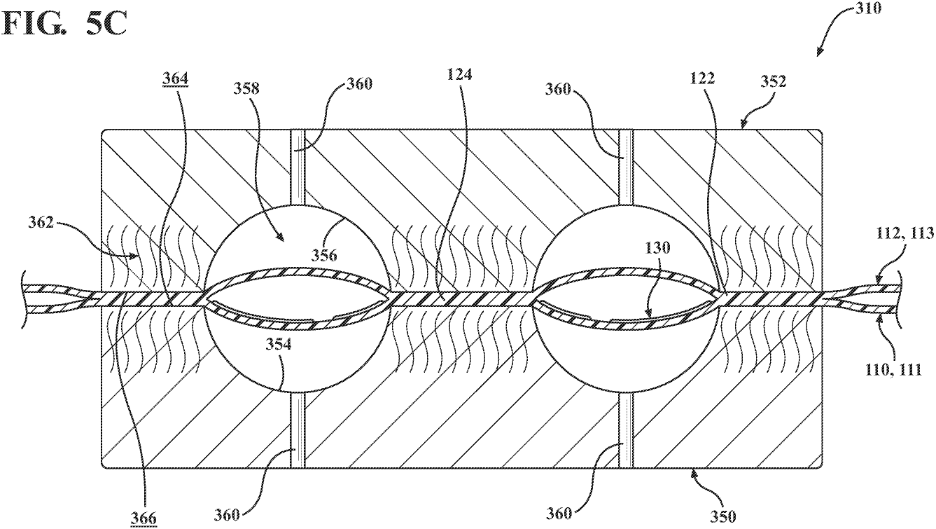

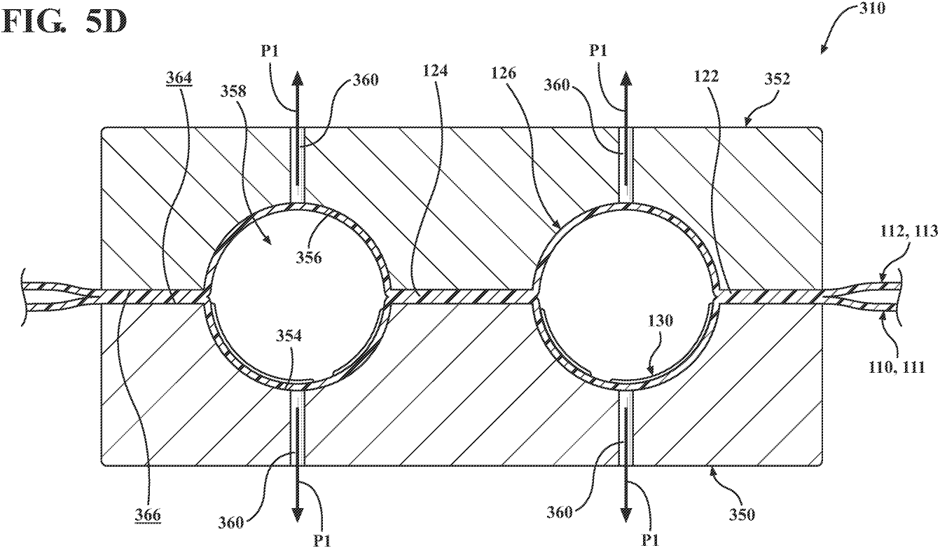

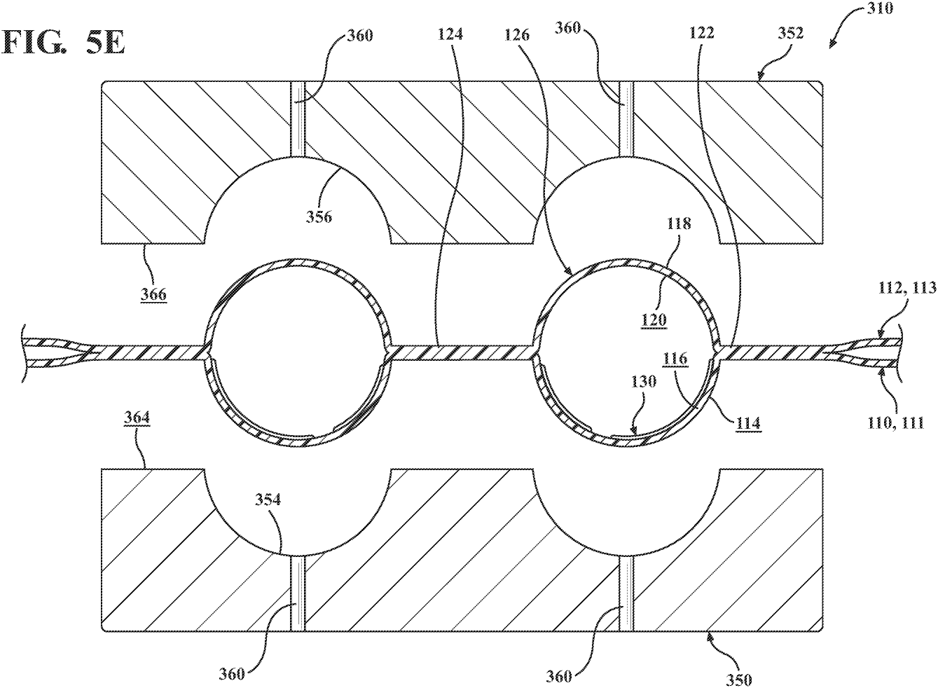

Referring to FIG. 1B, the example of the bladder 108 shown in FIG. 1A is shown independent of the sole structure 100. In the illustrated example, the bladder 108 of the midsole 102 includes an opposing pair of barrier sheets 110, 112 including an upper, first barrier sheet 110 and a lower, second barrier sheet 112. The first barrier sheet 110 defines a first exterior surface 114 and a first interior surface 116 (FIG. 5E) formed on an opposite side of the first barrier sheet 110 from the first exterior surface 114. Likewise, the second barrier sheet 112 includes a second exterior surface 118 and a second interior surface 120 formed on an opposite side of the second barrier sheet 112 than the second exterior surface 118. The first interior surface 116 of the first barrier sheet 110 is joined to the second interior surface 120 of the second barrier sheet 112 at discrete locations to define a peripheral seam 122 and an optional web area 124 that cooperate to form a chamber 126. Here, the peripheral seam 122 refers to the portion of the bladder 108 where the barrier sheets 110, 112 are joined together along an outer periphery of the chamber 126 and extend to a distal or terminal edge, while the web area 124 refers to portions of the bladder 108 where the barrier sheets 110, 112 are joined together and extend from a first edge attached to a first portion of the chamber 126 to a second edge attached to a second portion of the chamber 126. Thus, in the present example, the chamber 126 includes a U-shaped chamber having a pair of side segments connected by an arcuate rear segment, whereby the web area 126 extends between and connects all three segments along an interior portion of the bladder 124. While the bladder 108 of the present example includes a U-shaped chamber 126, the principles of the present disclosure can be applied to a bladder having any shape. Furthermore, the web area 124 may extend between and connect less than all of the segments of the chamber 126. For example, the web area 124 may only connect first and second segments of a chamber 126, while other segments of the chamber 126 are defined entirely by the peripheral seam.

As used herein, the term “polymeric film” (e.g., barrier sheets 110, 112) encompasses both single-layer and multi-layer films. In some embodiments, one or both of barrier sheets 110, 112 are each produced (e.g., thermoformed or blow molded) from a single-layer film. In other embodiments, one or both of the barrier sheets 110, 112 are each produced (e.g., thermoformed or blow molded) from a multi-layer film. In either of these aspects, each layer or sublayer can have a film thickness ranging from about 0.2 micrometers to about 1 millimeter. In further embodiments, the film thickness for each layer or sublayer can range from about 0.5 micrometers to about 500 micrometers. In yet further embodiments, the film thickness for each layer or sublayer can range from about 1 micrometer to about 100 micrometers.

At least one of the barrier sheets 110, 112 is transparent and the other one of the barrier sheets 110, 112 can be any one of transparent, translucent, and/or opaque. As used herein, the term “transparent” for a polymeric film and/or a fluid-filled chamber means that light passes through the polymeric film in substantially straight lines and a viewer can see through the polymeric film. In comparison, for an opaque polymeric film, light does not pass through the polymeric film and one cannot see clearly through the polymeric film at all. A translucent polymeric film falls between a transparent polymeric film and an opaque polymeric film, in that light passes through a translucent layer but some of the light is scattered so that a viewer cannot see clearly through the layer.

The barrier sheets 110, 112 can each comprise a polymeric material that includes one or more polymers. The one or more polymers can include, thermoplastic polymers, one or more thermosetting polymers, one or more thermoset polymers, or any combination thereof. In one aspect, the polymeric material is a thermoplastic material comprising one or more thermoplastic polymers. In other aspects, the polymeric material is a thermoplastic elastomeric material comprising one or more thermoplastic elastomeric polymers. The one or more polymers can include polyesters, polyethers, polyamides, polyolefins, polystyrenes, polyurethanes, or any combination thereof. In an aspect, the polymeric material can include one or more thermoplastic polymers, such as one or more thermoplastic polyurethane (TPU) polymers including one or more thermoplastic elastomeric polyester-polyurethane copolymers. In another aspect, the polymeric material can comprise one or more polymers having a low nitrogen gas transmission rate, such as one or more ethylene-vinyl alcohol (EVOH) copolymers, and the like.

As used herein, “polyurethane” refers to a polymer (including copolymers and oligomers) that contains a urethane group (—N(C═O)O—). These polyurethanes can contain additional groups such as ester, ether, urea, allophanate, biuret, carbodiimide, oxazolidinyl, isocynaurate, uretdione, carbonate, and the like, in addition to urethane groups. In an aspect, one or more of the polyurethanes can be produced by polymerizing one or more isocyanates with one or more polyols to produce copolymer chains having (—N(C═O)O—) linkages.

Examples of suitable isocyanates for producing the polyurethane polymer include diisocyanates, such as aromatic diisocyanates, aliphatic diisocyanates, and combinations thereof. Examples of suitable aromatic diisocyanates include toluene diisocyanate (TDI), TDI adducts with trimethyloylpropane (TMP), methylene diphenyl diisocyanate (MDI), xylene diisocyanate (XDI), tetramethylxylylene diisocyanate (TMXDI), hydrogenated xylene diisocyanate (HXDI), naphthalene 1,5-diisocyanate (NDI), 1,5-tetrahydronaphthalene diisocyanate, para-phenylene diisocyanate (PPDI), 3,3′ - dimethyldipheny1-4, 4′ -diisocyanate (DDDI), 4,4′-dibenzyl diisocyanate (DBDI), 4-chloro-1,3-phenylene diisocyanate, and combinations thereof.

In particular aspects, the polyurethane polymer chains are produced from diisocynates including HMDI, TDI, MDI, H12 aliphatics, and combinations thereof. In an aspect, the thermoplastic TPU can include polyester-based TPU, polyether-based TPU, polycaprolactone-based TPU, polycarbonate-based TPU, polysiloxane-based TPU, or combinations thereof.

In another aspect, the polymeric material can include one or more of the following polymers: EVOH copolymers, poly(vinyl chloride), polyvinylidene polymers and copolymers (e.g., polyvinylidene chloride), polyamides (e.g., amorphous polyamides), amide-based copolymers, acrylonitrile polymers (e.g., acrylonitrile-methyl acrylate copolymers), polyethylene terephthalate, polyether imides, polyacrylic imides, and other polymeric materials known to have relatively low nitrogen gas transmission rates. Blends of these materials as well as with the TPU polymers described herein and optionally including combinations of polyimides and crystalline polymers, are also suitable.

The barrier sheets 110, 112 may include two or more layers (i.e., as a multi-layer film). In further embodiments, barrier sheets 110, 112 may each independently include alternating layers of a first polymeric material comprising a TPU polymer, including a thermoplastic elastomeric polyester-polyurethane, and a second polymeric material comprising one or more polymers having a low nitrogen gas transmission rate, such as an EVOH copolymer. The total number of alternating layers in each of the barrier sheets 110, 112 can include at least four (4) sublayers, at least ten (10) sublayers, at least twenty (20) sublayers, at least forty (40) sublayers, and/or at least sixty (60) sublayers.

The chamber 126 portion of the bladder 108 can be produced from the barrier sheets 110, 112 using any suitable technique, such as thermoforming (e.g. vacuum thermoforming), blow molding, extrusion, injection molding, vacuum molding, rotary molding, transfer molding, pressure forming, heat sealing, casting, low-pressure casting, spin casting, reaction injection molding, radio frequency (RF) welding, and the like. In an aspect, the barrier sheets 110, 112 can be produced by co-extrusion followed by vacuum thermoforming to produce an inflatable chamber 126, which can optionally include one or more valves (e.g., one-way valves) that allows the chamber 126 to be filled with the compressible material (e.g., gas, elastomeric material, spacer textile).

The chamber 126 can be provided in a fluid-filled state (e.g., as provided in footwear 10) or in an unfilled state. The chamber 126 can be filled to include any suitable fluid, such as a gas or liquid. In an aspect, the gas can include air, nitrogen (N₂), or any other suitable gas. The fluid provided to the chamber 126 can result in the chamber 126 being pressurized. In some examples, the pressure of the fluid ranges from 5 psi to 35 psi, and more particularly from 20 psi to 35 psi, and more particularly from 25 psi to 35 psi. Alternatively, the fluid provided to the chamber 126 can be at atmospheric pressure such that the chamber 126 is not pressurized but, rather, simply contains a volume of fluid at atmospheric pressure. In other aspects, the chamber 126 can alternatively include other media, such as pellets, beads, ground recycled material, and the like (e.g., foamed beads and/or rubber beads).

With continued reference to FIG. 1B, in addition to the barrier sheets 110, 112, the bladder 108 includes a bead layer 130 disposed on the first interior surface 116 and/or the second interior surface 120. Accordingly, the bead layer 130 is disposed within the interior void of the chamber 126. The bead layer 130 may alternatively be referred to as a pattern layer 130 disposed on one of the first interior surface 116 and/or the second interior surface 120. As discussed below, the pattern layer 130 may be applied to the interior surfaces 116, 120 as a deposited bead having a predefined pattern. The pattern of the bead layer 130 may be tuned to provide a desired aesthetic effect and/or performance characteristic to the bladder 108.

The bead layer 130 may be formed of the same materials used to form the barrier sheets 110, 112. Accordingly, as discussed above, the bead layer 130 may include one or more thermoplastic polyurethane (TPU) polymers. By using the same materials for the barrier sheets 110, 112 and the bead layer 130, excess material of the barrier sheets 110, 112 can be recycled and reused as the material for the bead layer 130. Additionally, using homogenous materials for each of the barrier sheets 110, 112 and the bead layer 130 allows the entire bladder 108 to be recycled using the same recycling processes such that all of the materials of the bladder 108 can be reused in forming new barrier sheets 110, 112 or bead layers 130. In some examples, the bead layer 130 may include one or more colorants to provide a visible contrast between the bead layer 130 and the transparent barrier sheet 110, 112 upon which the bead layer 130 is applied.

In the example of FIG. 1B, the bead layer 130 includes a plurality of bead segments 132 defining the pattern of the bead layer 130. For the sake of discussion, the term “bead segment” refers to any continuous span of the bead layer 130 extending between terminal ends 134, intersections 136 (e.g., a point where two bead segments 132 converge with no radius), and/or turns 138 (e.g., a span of bead material having a relatively small radius compared to adjacent straight or curved portions of bead segments 132). As discussed in greater detail below, the population density or concentration of the bead segments 132 may be variable along the interior surfaces 116, 120 of the barrier sheets 110, 112. For example, a first area A1 of the bead layer 130 may have bead segments 132 that are spaced together more densely than a second area of the bead layer 130 to provide the first area of the bead layer with a greater concentration of the bead segments 132 than the second area A2. Providing different concentrations of the bead segments 132 may provide an aesthetic effect to the bladder 108. However, the concentrations and orientations of the bead segments 132 may also be selected to tune the performance of the bladder 108. For example, areas of the bladder 108 having a relatively high concentration of bead segments may be more resistant to stretching or expansion when compressed, thereby providing a harder cushioning feel. In other words, the bead segments 132 may act as tensile elements along the interior surfaces 116, 120 of the bladder 108 to control stretching of the barrier sheets 110, 112.

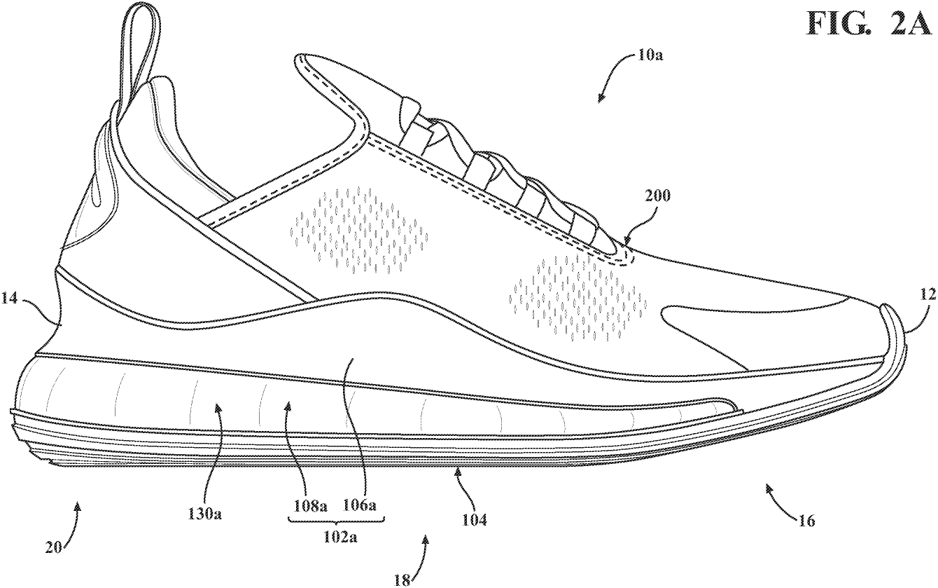

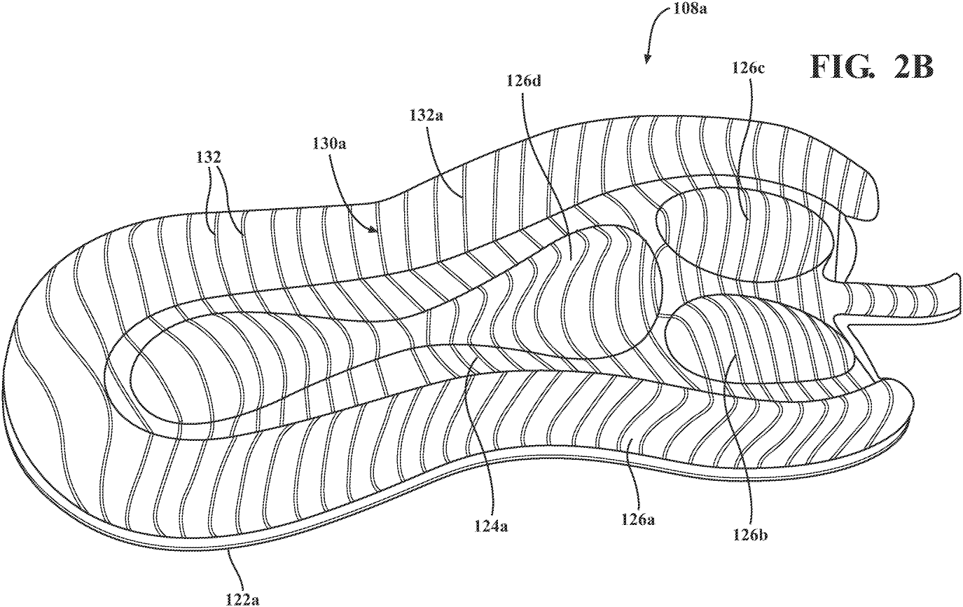

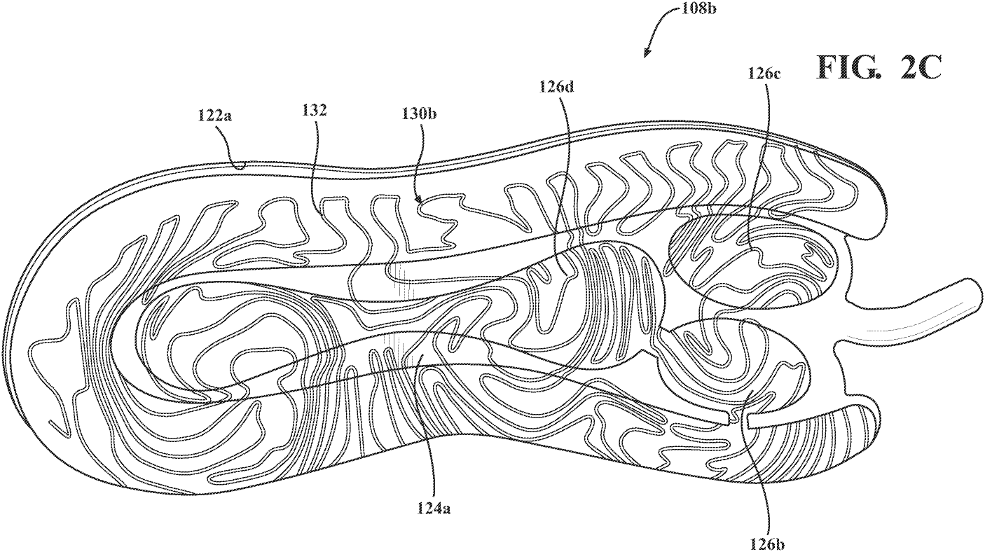

With particular reference to FIGS. 2A-2B, an article of footwear 10a is provided and includes a sole structure 100a and the upper attached to the sole structure 100a. In view of the substantial similarity in structure and function of the components associated with the article of footwear 10 with respect to the article of footwear 10a, like reference numerals are used hereinafter and in the drawings to identify like components while like reference numerals containing letter extensions are used to identify those components that are different relative to the article of footwear 10.

Referring to FIG. 2A, the article of footwear 10a includes a midsole 102a and an outsole 104a attached to the midsole 102a. Here, the midsole 102a includes a cushioning element 106a that receives a bladder 108a. Like the bladder 108 described previously, the bladder 108a may be formed by joining an upper barrier sheet 110 and a lower barrier sheet 112 together along a peripheral seam 122a and a web area 124a to define one or more chambers 126a-126d. In the illustrated example, the bladder 108a is provided as a “full-length” bladder that extends through each of the forefoot region 16, the midfoot region 18, and the heel region 20. Similar to the bladder 108 described above, the bladder 108a may include a bead layer 130a (FIG. 9B) applied on an interior surface 116, 120 of one of the barrier sheets 110, 112.

Referring to FIG. 2B, an example of the bladder 108a including a bead layer 130a having a first pattern is shown. The bladder 108a may include an outer peripheral chamber 126a having a pair of elongate side segments and an arcuate heel segment. The web area 124a connects each of the segments of the peripheral chamber 126a and may further include one or more interior chambers 126b-126c. In this example, the bead layer 130a includes a plurality of the bead segments 132 each extending in a lateral direction (i.e., from medial to lateral) across the bladder 108a. As shown, some of the bead segments 132 extend across the bladder 108a and through at least one of the chambers 126a and the web area 124a, while other bead segments 132 extend only along one of the chambers 126a-126d. In other examples, all of the bead segments 132 may be limited to the chambers 126a-126d and do not extend into the web area 124a.

FIG. 2C shows another example of a full-length bladder 108a including a bead layer 130b having an irregular pattern. Unlike the bead layer 130a, which extends through the chambers 126a-126d and the web area 124a, the bead layer 130b is constrained to the chambers 126a-126d and does not extend into the web area 124a. In this example, the bead layer 130b has a pattern including a variable concentration (i.e., spacing) of bead segments 132 .

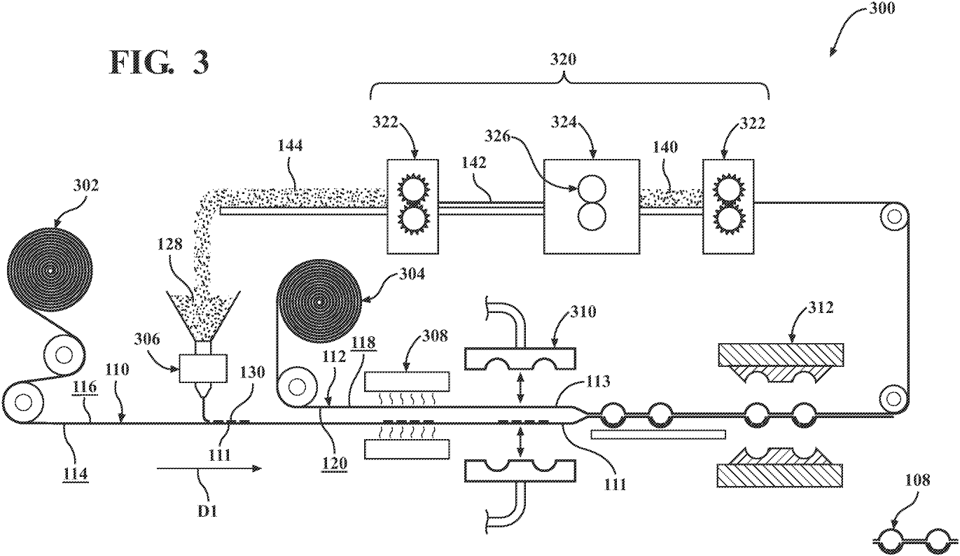

Referring to FIG. 3, a schematic view of a system 300 for producing a bladder 108 according to the present disclosure is provided. The system 300 includes a first spool 302 of barrier material for forming the first barrier sheet 110, a second spool 304 of barrier material for forming the second barrier sheet 112, and an extrusion system 306 for applying the bead layer 130 to the first interior surface 116 of the first barrier sheet 110. While illustrated example includes a single extrusion system 306 configured to apply the bead layer 130 only to the first interior surface 116 of the first barrier sheet 110, the system 300 may include a second extrusion system 306 for applying a bead layer 130 to the second interior surface 120 or may be configured such that each of the first interior surface 116 and the second interior surface 120 can be exposed to a single extrusion system 306 for application of the bead layer 130.

The system 300 further includes a heating unit 308 and a vacuum forming press 310 disposed downstream of the first spool 302, the second spool 304, and the extrusion system 306. The heating unit 308 is configured to subject each of the barrier sheets 110, 112 and the bead layer 130 to thermal energy to soften the barrier sheets 110, 112 and bead layer 130 prior to entry into the vacuum forming press 310. For clarity, the heating unit 308 is shown as being disposed upstream of the vacuum forming press 310 relative to a direction of travel D1 of the first and second barrier sheets 110, 112 within the system 300. However, the heating unit 308 may be integrated within the vacuum forming press 310 to heat the barrier sheets 110, 112 upon entry into the vacuum forming press 310 and immediately prior to a vacuum forming operation, as discussed below. For example, the heat unit 308 may be provided on a shuttle mechanism (not shown) operable to selectively move the heating unit 308 into and out of the vacuum forming press 310 prior to the vacuum forming operation.

The system 300 further includes a trimmer 312 operable to separate the formed bladder 108 from the barrier sheets 110, 112 after the vacuum forming operation. While the illustrated example of the trimmer 312 includes a trimming die configured to separate the bladder 108 from the barrier sheets 110, 112 by a stamping process, the trimmer 312 may include other devices for separating the bladder 108 from the barrier sheets 110, 112. For example, the trimmer 312 may include a computer numerical controlled (CNC) cutting system programmed to cut the peripheral profile of the bladder 108 from the barrier sheets 110, 112.

Referring still to FIG. 3, the system 300 may optionally include a milling system 320 including a series of grinders or pelletizers 322, mixers 324, and rollers 326 for recycling excess barrier material of the barrier sheets 110, 112 into bead material 128 for the bead layer 130. For example, the excess barrier material of the barrier sheets 110, 112 is provided from the trimmer 312 to a material grinder 322 that grinds or pelletizes the barrier sheets 110, 112 into a granular or pellet structure. The pellets 140 of the barrier material may be provided to a mixer 324 for mixing with one or more additives, such as a colorant (e.g., a dye), and reforming the mixture of the barrier material pellets 140 and additives into a sheet 142 of the bead material 128 having one or more colors. The milling system 320 further includes a second grinder 322 for pelletizing the sheet 142 of the bead material 128 into pellets 144 of the bead material 128, which are then provided to the extrusion system 306 for deposition on the barrier sheets 110, 112.

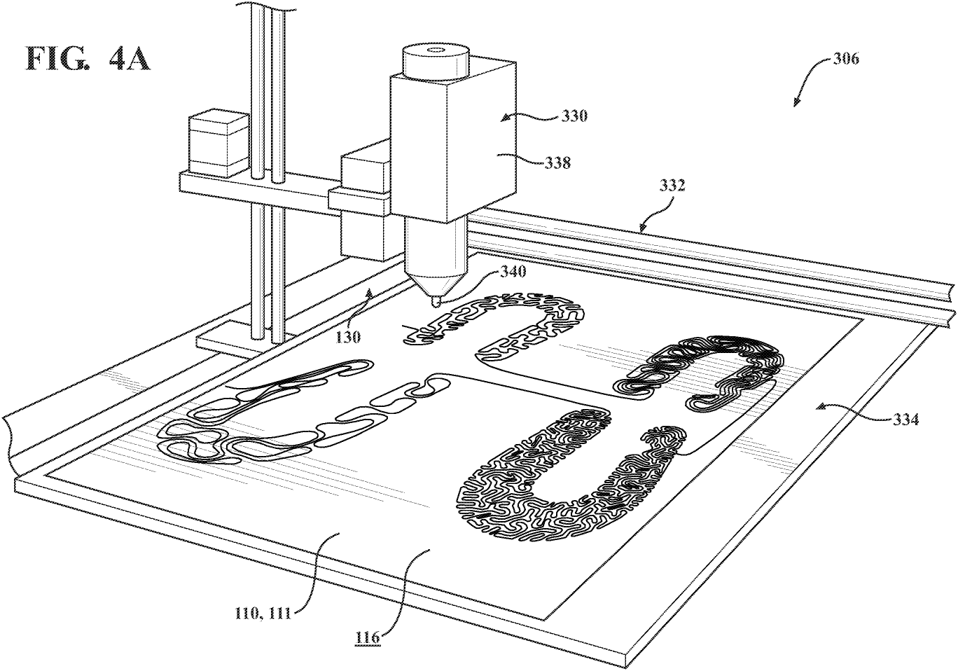

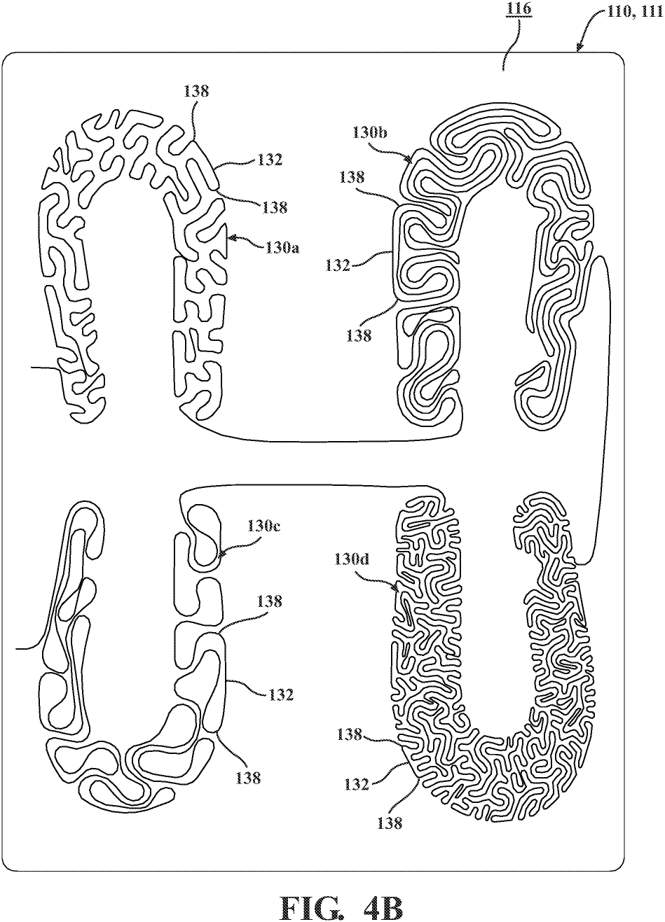

Referring to FIG. 4A, a detailed example of an extrusion system 306 is shown. As provided, the extrusion system 306 includes an extruder unit 330 mounted to a gantry system 332 configured for two-axis travel along an x-axis (e.g. side-to-side) and a y-axis (e.g., front-to-back). Optionally, the extruder unit 330 may also be configured for movement along a z-axis (e.g., up and down). For example, the extruder unit 330 may be provided as an end effector on a multi-axis (e.g., six-axis) robotic arm. The extrusion system 306 is mounted over a conveyor bed 334 that supports one of the barrier sheets 110, 112 beneath the extrusion system 306 with the interior surface 116, 120 presented to the extruder unit 330. The extruder unit 330 may include an extruder hopper 338 for storing the pelletized bead material 128 and an extruder having an extruder nozzle 340 for applying the bead layer 130. The extruder nozzle 340 may be configured to apply a bead layer 130 having desired size (e.g., thickness, diameter, width) and/or profile (e.g., round, flat). In some examples, the extruder nozzle 340 may be interchangeable such that different sizes and profiles of bead layers 130 can be applied as desired. As discussed below, FIG. 4B provides an example of an extrusion pattern including four different bead layer patterns 130a-130d applied to the first interior surface 116 of the first barrier sheet 110.

FIGS. 5A-5E illustrate an example of the vacuum forming press 310. As shown in FIG. 5A, the vacuum forming press 310 includes a lower, first mold plate 350 and an upper, second mold plate 352. The first mold plate 350 defines a first mold cavity 354 having a profile corresponding to a desired profile of a first portion of the chamber 126 of the bladder 108 formed by the first barrier sheet 110. Likewise, the second mold plate 352 defines a second mold cavity 356 having a profile corresponding to a desired profile of a second portion of the chamber 126 of the bladder 108 formed by the second barrier sheet 112. Accordingly, when the vacuum forming press 310 is in the closed configuration (FIGS. 3B-3D), the first mold cavity 354 and the second mold cavity 356 cooperate to define a mold chamber 358 having a shape corresponding to the chamber 126 of the bladder 108. Each mold plate 350, 352 includes a plurality of vacuum ports 360 in communication with an external vacuum source (not shown). As described below, the vacuum ports 360 draw negative pressure P1 within the mold chamber 358 to draw the barrier sheets 110, 112 against the surfaces of the respective mold cavities 354, 356. As shown in FIG. 5C, each mold plate 350, 352 may further include a sealing system 362 integrated therein for joining the first barrier sheet 110 to the second barrier sheet 112. The sealing system 362 may include any means for joining the first barrier sheet 110 and the second barrier sheet 112, such as a thermal sealing system (e.g., for melding the barrier sheets together) and/or a radio frequency (RF) sealing system (e.g., for welding the barrier sheets together).

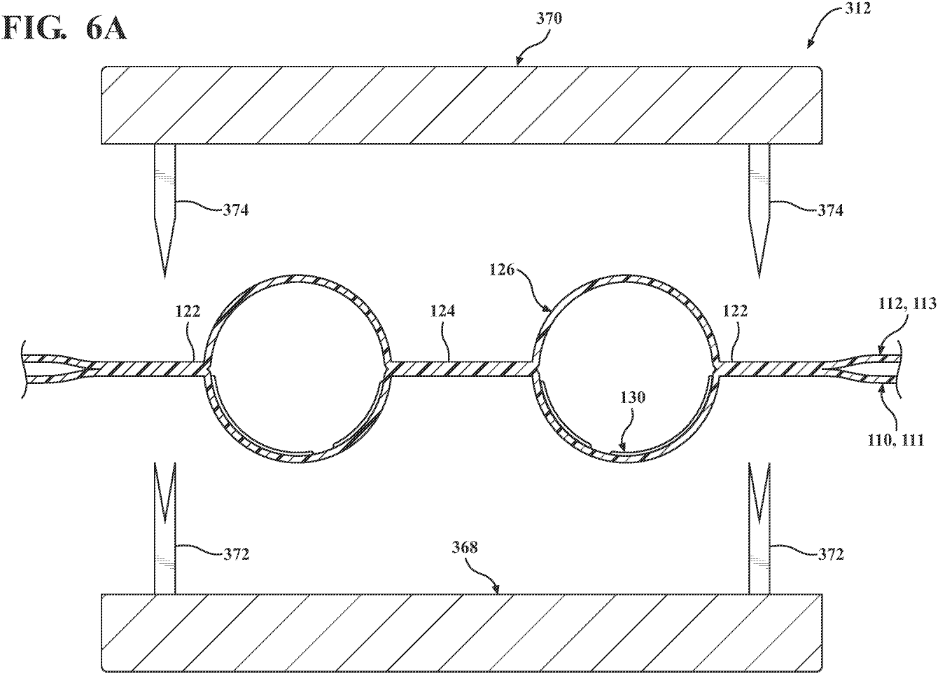

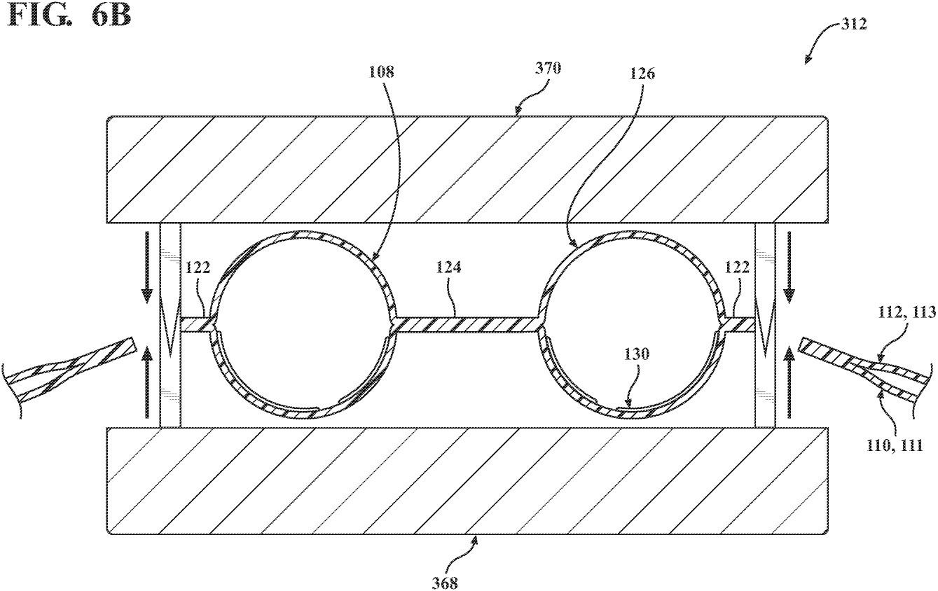

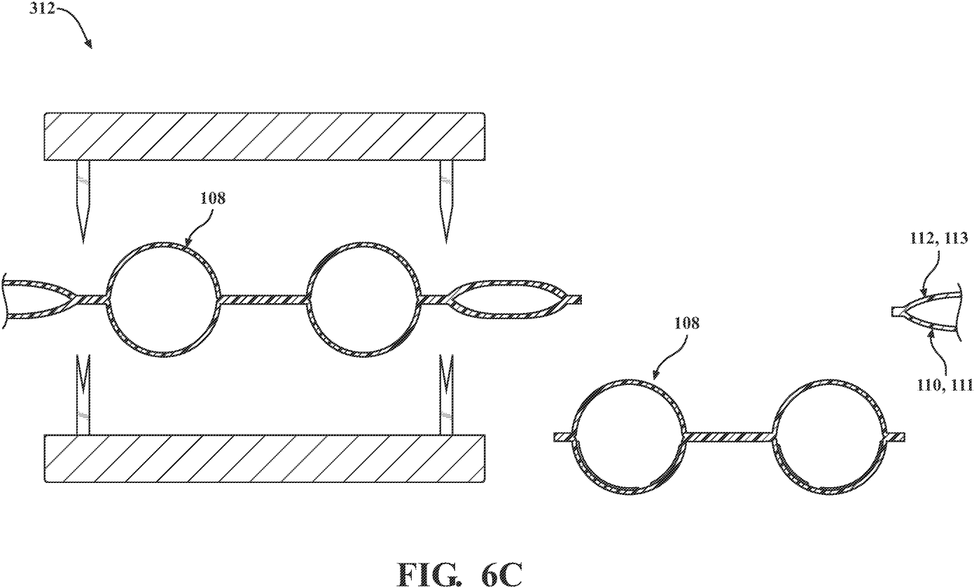

In FIGS. 6A and 6B, an example of a trimmer 312 is embodied as a trimming die. The trimming die 312 includes a first trim plate 368 and a second trim plate 370 each including respective trim tooling 368, 370 for separating the formed bladder 108 from the excess barrier material of the first barrier sheet 110 and the second barrier sheet 112. Operation of the trimmer 312 will be described in greater detail below.

Referring to FIG. 3-6C, steps for forming a bladder 108 including an internal bead layer 130 are provided. Initially, the first barrier sheet 110 is provided from the first spool 302 as a continuous sheet. Here, the barrier sheet 110 may be designated with a plurality of sheet segments 111 each corresponding to a single bladder 108 or batch of bladders 108. For example, the system 300 of FIG. 3 is configured to process a single bladder 108 at each operation such that the vacuum forming press 310 only defines a single mold chamber 358. However, the bladder system 300 may be configured to process batches of bladders 108 at each operation. For instance, the vacuum forming press 310 may include a plurality of mold chambers 358 each configured to form a single bladder 108 such that each sheet segment 111 corresponds to a designated batch of the bladders 108.

In use, each sheet segment 111 is sequentially advanced through the stations 306, 308, 310, 312 of the bladder system 300. In the illustrated example, the first barrier sheet 110 includes four sheet segments 111 corresponding to the stations 306, 308, 310, 312. For example, a first sheet segment 111 may be positioned at the trimmer 312 while the fourth sheet segment 111 is staged at the extrusion system 306. Optionally, the first barrier sheet 110 may be provided as individual sheet segments 111 that are loaded into and unloaded from the extrusion system 306.

From the first spool 302, the first barrier sheet 110 advances to the extrusion system 306 where the first interior surface 116 of the first barrier sheet 110 is presented to the extruder nozzle 340 for application of the bead layer 130, as shown in FIG. 4A. In the example of FIG. 4A, the extrusion system 306 is shown in an intermediate stage of applying the bead layer 130 to the first interior surface 116 of the first barrier sheet. As shown, the bead layer 130 of the illustrated example includes a single, continuous bead layer 130 having a plurality of bead segments 132 connected by turns 138.

As previously mentioned, the bladder system 300 may be configured to form batches of the bladders 108 at each operation. For example, the bladder system 300 may be configured to form batches of four bladders 108 at each sheet segment 111. As shown in FIG. 4B, when the bladder system 300 is configured to form four bladders 108, the extrusion system 306 may be programmed to deposit four separate bead layer patterns 130a-130d upon different areas of the first interior surface 116 of the first barrier sheet 110. Here, each of the bead layer patterns 130a-130d is associated with a respective chamber 126 of a corresponding bladder 108. While each of the bead layer patterns 130a-130d may include the same pattern for forming four identical bladders 108, the extrusion system 306 may also be programmed to deposit bead layer patterns 130a-130d having different characteristics from each other. For example, one or more of the bead layer patterns 130a-130d may have a different scale (i.e., size ratio), segment concentration, color, segment arrangement, and/or profile (e.g., overall shape) from one or more of the other bead layer patterns 130a-130d. Accordingly, the extrusion system 306 can provide real-time customization to the appearance and performance of each bladder 108 by executing a different bead application program to apply different bead layer patterns 130a-130d to the first interior surface 116 of the first barrier sheet.

Referring again to FIG. 4A, the bead layer 130 is configured to be disposed entirely within the chamber 126 of the bladder 108. In other words, the bead layer 130 is contained to the portions of the first interior surface 116 corresponding to the chamber 126 and does not extend into the peripheral seam 122 and the web area 124. Maintaining the bead layer 130 within the chamber 126 maximizes surface contact between the interior surfaces 116, 120 of the barrier sheets 110, 112 when the barrier sheets 110, 112 are joined together, thereby ensuring integrity of the seal formed between the barrier sheets 110, 112 is not interrupted by the bead layer 130.

Optionally, the size of the bead layer 130 may be scaled to accommodate for stretching of the first barrier sheet 110 and the bead layer 130 during the bladder forming process. For example, during subsequent heating and vacuum forming operations, material of the first barrier sheet 110 and the bead layer 130 may be softened to increase compliance and improve conformance with the mold cavities 354, 356. However, some deformation or sagging may occur between the heating unit 308 and the vacuum forming press 310, causing the pattern of the bead layer 130 to expand (i.e., stretch) from the original size applied to the first barrier sheet 110 by the extrusion system 306. To compensate for post-heat stretching, the scale of the applied bead layer 130 may be reduced by a scaling factor (e.g., 10% reduction) from the final size of the bead layer 130 in the formed bladder 108. Downscaling the size of the applied bead layer 130 further ensures that the bead layer 130 will not extend into the peripheral seam 122 or web area 124 when the bladder 108 is formed at the vacuum forming press 310.

Once the bead layer 130 is applied to the first interior surface 116, the first sheet segment 111 of the first barrier sheet 110 is advanced to the heating unit 308 to soften the first barrier sheet 110 and the bead layer 130. Simultaneously, a corresponding sheet segment 113 of the second barrier sheet 112 is advanced to the heating unit 308 for softening. The first sheet segment 111 of the first barrier sheet 110 and the second sheet segment 113 of the second barrier sheet 112 correspond to a single bladder 108 or batch of bladders 108 to be formed by the vacuum forming press 310.

Each of the first sheet segment 111 including the bead layer 130 and the second sheet segment 113 then advance to the vacuum forming press 310. With reference to FIG. 5A, at a first step of the vacuum forming operation, the vacuum forming press 310 is provided in an open configuration with the first mold plate 350 spaced apart from the second mold plate 352. Here, the softened barrier sheets 110, 112 are disposed between the mold plates 350, 352 with the first interior surface 116 including the bead layer 130 facing the second interior surface 120 of the second barrier sheet 112. As previously discussed, the bead layer 130 is scaled to align with the mold cavities 354, 356 such that no portion of the bead layer 130 extends between opposing sealing surfaces 364, 366 of the sealing system 362.

With the first and second sheet segments 111, 113 aligned between the first and second mold plates 350, 352, the mold plates 350, 352 move to a closed position shown in FIG. 5B. In the closed position, portions of the first sheet segment 111 and second sheet segment 113 corresponding to the peripheral seam 122 and web area 124 are compressed between the first sealing surface 364 of the first mold plate 350 and the second sealing surface 366 of the second mold plate 352. The portions of the first sheet segment 111 and the second sheet segment 113 corresponding to the chamber 126 of the bladder 108 and including the bead layer 130 are disposed within the mold chamber 358 defined by the first mold cavity 354 and the second mold cavity 356.

Referring to FIG. 5C, the first sheet segment 111 and the second sheet segment 113 are joined together between the sealing surfaces 364, 366 of the mold plates 350, 352 to form the peripheral seam 122 and the web area 124. As previously provided, the first sheet segment 111 and the second sheet segment 113 may be j oined together by any suitable technique, such as a heat sealing process or a radio frequency (RF) welding process. Once the interior surfaces 116, 120 of the sheet segments 111, 113 are joined together, negative pressure P1 is provided through the vacuum ports 360 of the mold plates 350, 352 to draw the exterior surfaces 114, 118 of the sheet segments 111, 113 against the surfaces of the respective mold cavities 354, 356 to form the profile of the chamber 126. Optionally, a positive pressure may be provided within the chamber 126 to modify a compressibility of the chamber 126. For example, the pressure of the fluid may range from 5 psi to 35 psi, and more particularly from 20 psi to 35 psi, and more particularly from 25 psi to 35 psi. Once the chamber 126 is formed, the vacuum forming press 310 moves to the open configuration shown in FIG. 5E and the chamber 126 is ejected from the mold cavities 354, 356.

With continued reference to FIG. 3, the sheet segments 111, 113 including the molded chamber 126 advance to the trimmer 312 for separation from the sheet segments 111, 113. As shown in FIG. 6A, the chamber 126 is aligned within the trimming die 312 such that the peripheral seam 122 is aligned between the first trim tool 372 and the second trim tool 374. In FIG. 6B, the trimming die 312 moves to a closed position to sever the bladder 108 from the first and second sheet segments 111, 113 along the peripheral seam 122. As previously discussed, the trimmer 312 may be embodied as other configurations, including a programmable CNC trimmer configured to cut along the peripheral seam 122 of the bladder 108.

At FIG. 6C, the bladder system 300 advances by one operation such that the separated bladder 108 is removed from the trimmer 312 and a new bladder 108 is loaded into the trimmer 312. Once the bladder 108 is separated from the first and second barrier sheets 110, 112, the excess remnants 110a, 112a of the first and second barrier sheets 110, 112 are provided to the milling system 320 for pelletizing and reformation as the bead material 128. Thus, the bladder system 300 is configured to recycle the material of the barrier sheets 110, 112 to be used as bead material 128 in the bead layer 130. The foregoing process provides a closed-loop system that allows scrap material of the barrier sheets 110, 112 to be continuously recycled and used in subsequent bladders 108.

The following Clauses provide exemplary configurations for a bladder, a method of forming a bladder, a sole structure, and an article of footwear in accordance with the present disclosure.

Clause 1. A bladder for a wearable article, the bladder comprising a first barrier sheet including a first surface and a second surface disposed on an opposite side from the first surface, a second barrier sheet including a third surface and a fourth surface disposed on an opposite side from the third surface and attached to the second surface of the first barrier sheet to define a chamber, and a bead layer disposed on at least one of the second surface or the fourth surface within the chamber.

Clause 2. The bladder of Clause 1, wherein the first barrier sheet and the second barrier sheet include a first polymeric material and the bead layer includes a second polymeric material.

Clause 3. The bladder of Clause 2, wherein the first polymeric material is the same as the second polymeric material.

Clause 4. The bladder of Clause 2, wherein the first polymeric material includes a transparent material and the second polymeric material includes a colored material.

Clause 5. The bladder of any of the preceding Clauses, wherein the bead layer includes a continuous bead of polymeric material disposed on the at least one of the second surface or the fourth surface.

Clause 6. The bladder of any of the preceding Clauses, wherein the bead layer includes a first concentration of bead segments in a first area of the chamber and a second concentration of bead segments in a second area of the chamber.

Clause 7. The bladder of Clause 6, wherein the first concentration of bead segments is greater than or less than the second concentration of bead segments.

Clause 8. The bladder of any of the preceding Clauses, wherein the bead layer is an extruded bead layer applied to the at least one of the second surface or the fourth surface.

Clause 9. The bladder of any of the preceding Clauses, wherein the second surface of the first barrier sheet is attached to the fourth surface of the second barrier sheet to form a web area extending between a first portion of the chamber and a second portion of the chamber, the bead layer being spaced apart from the web area.

Clause 10. The bladder of any of the preceding Clauses, wherein a first portion of the bead layer includes a first pattern and a second portion of the bead layer includes a second pattern.

Clause 11. A method of forming a bladder for a wearable article, the method comprising providing a first barrier sheet including a first surface and a second surface disposed on an opposite side from the first surface, depositing a bead layer upon a predetermined area of the second surface, and attaching a second barrier sheet to the second surface of the first barrier sheet outside of the predetermined area of the bead layer to define one or more chambers enclosing the bead layer.

Clause 12. The method of Clause 11, further comprising forming the first barrier sheet and the second barrier sheet with a first polymeric material and forming the bead layer with a second polymeric material.

Clause 13. The method of Clause 12, wherein forming the second polymeric material includes recycling the first polymeric material.

Clause 14. The method of Clause 12, wherein forming the second polymeric material includes adding a colorant to the first polymeric material.

Clause 15. The method of any of the preceding Clauses, wherein depositing the bead layer includes extruding a continuous bead of polymeric material upon the second surface of the first barrier sheet.

Clause 16. The method of any of the preceding Clauses, wherein depositing the bead layer includes depositing a first concentration of bead segments in a first area of the bead layer and depositing a second concentration of bead segments in a second area of the bead layer.

Clause 17. The method of Clause 16, wherein depositing the first concentration of bead segments includes depositing a different concentration of bead segment than the second concentration of bead segments.

Clause 18. The method of any of the preceding Clauses, further comprising separating the one or more chambers from the first barrier sheet and the second barrier sheet to form a first barrier sheet remnant and a second barrier sheet remnant, and providing the first barrier sheet remnant and the second barrier sheet remnant to a milling system for forming a bead material.

Clause 19. The method of any of the preceding Clauses, wherein depositing the bead layer upon the second surface includes depositing a plurality of bead layer patterns each associated with one of the one or more chambers.

Clause 20. The method of any of the preceding Clauses, wherein depositing the plurality of bead layer patterns includes depositing a first bead layer pattern having a first bead characteristic and a second bead layer pattern having a second bead characteristic different than the first bead characteristic.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A bladder for a wearable article, the bladder comprising:
a first barrier sheet including a first surface and a second surface disposed on an opposite side from the first surface;
a second barrier sheet including a third surface and a fourth surface disposed on an opposite side from the third surface and attached to the second surface of the first barrier sheet to define a chamber; and
a bead layer disposed on at least one of the second surface or the fourth surface within the chamber.

2. The bladder of claim 1, wherein the first barrier sheet and the second barrier sheet include a first polymeric material and the bead layer includes a second polymeric material.

3. The bladder of claim 2, wherein the first polymeric material is the same as the second polymeric material.

4. The bladder of claim 2, wherein the first polymeric material includes a transparent material and the second polymeric material includes a colored material.

5. The bladder of claim 1, wherein the bead layer includes a continuous bead of polymeric material disposed on the at least one of the second surface or the fourth surface.

6. The bladder of claim 1, wherein the bead layer includes a first concentration of bead segments in a first area of the chamber and a second concentration of bead segments in a second area of the chamber.

7. The bladder of claim 6, wherein the first concentration of bead segments is greater than or less than the second concentration of bead segments.

8. The bladder of claim 1, wherein the bead layer is an extruded bead layer applied to the at least one of the second surface or the fourth surface.

9. The bladder of claim 1, wherein the second surface of the first barrier sheet is attached to the fourth surface of the second barrier sheet to form a web area extending between a first portion of the chamber and a second portion of the chamber, the bead layer being spaced apart from the web area.

10. The bladder of claim 1, wherein a first portion of the bead layer includes a first pattern and a second portion of the bead layer includes a second pattern.

11. A method of forming a bladder for a wearable article, the method comprising:
providing a first barrier sheet including a first surface and a second surface disposed on an opposite side from the first surface;
depositing a bead layer upon a predetermined area of the second surface; and
attaching a second barrier sheet to the second surface of the first barrier sheet outside of the predetermined area of the bead layer to define one or more chambers enclosing the bead layer.

12. The method of claim 11, further comprising forming the first barrier sheet and the second barrier sheet with a first polymeric material and forming the bead layer with a second polymeric material.

13. The method of claim 12, wherein forming the second polymeric material includes recycling the first polymeric material.

14. The method of claim 12, wherein forming the second polymeric material includes adding a colorant to the first polymeric material.

15. The method of claim 11, wherein depositing the bead layer includes extruding a continuous bead of polymeric material upon the second surface of the first barrier sheet.

16. The method of claim 11, wherein depositing the bead layer includes depositing a first concentration of bead segments in a first area of the bead layer and depositing a second concentration of bead segments in a second area of the bead layer.

17. The method of claim 16, wherein depositing the first concentration of bead segments includes depositing a different concentration of bead segment than the second concentration of bead segments.

18. The method of claim 11, further comprising separating the one or more chambers from the first barrier sheet and the second barrier sheet to form a first barrier sheet remnant and a second barrier sheet remnant, and providing the first barrier sheet remnant and the second barrier sheet remnant to a milling system for forming a bead material.

19. The method of claim 11, wherein depositing the bead layer upon the second surface includes depositing a plurality of bead layer patterns each associated with one of the one or more chambers.

20. The method of claim 19, wherein depositing the plurality of bead layer patterns includes depositing a first bead layer pattern having a first bead characteristic and a second bead layer pattern having a second bead characteristic different than the first bead characteristic.
